(19) United States
(12) Patent Application Publication
(10) Pub. No.: US 2026/0012846 A1
(43) Pub. Date: Jan. 8, 2026

(54) METHODS AND APPARATUS FOR SR/BSR REPORTING IN MULTIPATH SIDELINK RELAYS

(71) Applicant: INTERDIGITAL PATENT HOLDINGS, INC., Wilmington, DE (US)

(72) Inventors: Martino Freda, Laval (CA); Oumer Teyeb, Montreal (CA); Tuong Hoang, Montreal (CA); Ananth Kini, Conshohocken, PA (US)

(73) Assignee: INTERDIGITAL PATENT HOLDINGS, INC., Wilmington, DE (US)

(21) Appl. No.: 18/993,272

(22) PCT Filed: Jul. 11, 2023
(86) PCT No.: PCT/US2023/027380

§ 371 Date: Jan. 10, 2025

Related U.S. Application Data
(60) Provisional application No. 63/388,093, filed on Jul. 11, 2022.

(51) Int. Cl. H04W 28/02; H04W 72/25

(52) U.S. Cl. CPC H04W 28/0278; H04W 72/25

(57) ABSTRACT

A relay wireless transmit/receive unit (WTRU) may receive information from at least one remote WTRU and may comprise an indication of a set of sidelink (SL) logical channels (LCHs) that are associated with duplicated data and an indication of a resource allocation mode of the at least one remote WTRU. The relay WTRU may receive information from a network that may comprise an indication of an association of SL LCHs to Uu LCHs. The relay WTRU may trigger a BSR (or SR) when SL LCH data associated with a Uu LCH of the relay WTRU arrives from at least one remote WTRU that has a resource allocation mode of mode 2 and on a condition that at least one SL LCH from the at least one remote WTRU that has a resource allocation mode of mode 2 is not associated with duplicated data.

### CROSS-REFERENCE TO RELATED APPLICATIONS

This application claims the benefit of U.S. Provisional Application No. 63/388,093, filed Jul. 11, 2022, the contents of which are incorporated herein by reference.

### BACKGROUND

In Dual Connectivity (DC), a wireless transmit/receive unit (WTRU) is served by two nodes, each node comprising a set of cells known as a Master Cell Group (MCG) and a Secondary Cell Group (SCG). A bearer may be associated only with the MCG or SCG, or it may be configured to be a split bearer.

### SUMMARY

A method and apparatus for a scheduling request (SR)/buffer status report (BSR) reporting is disclosed. A relay wireless transmit/receive unit (WTRU) may receive information from at least one remote WTRU. The information from the at least one remote WTRU may comprise an indication of a set of sidelink (SL) logical channels (LCHs) that are associated with duplicated data and an indication of a resource allocation mode of the at least one remote WTRU. The relay WTRU may receive information from a network that may comprise an indication of an association of SL LCHs to Uu LCHs. The relay WTRU may trigger a BSR (or SR) when SL LCH data associated with a Uu LCH of the relay WTRU arrives from at least one remote WTRU that has a resource allocation mode of mode 2 and on a condition that at least one SL LCH from the at least one remote WTRU that has a resource allocation mode of mode 2 is not associated with duplicated data. The relay WTRU may determine parameters for the triggered BSR (or SR) for the Uu LCH of the relay WTRU based on an amount of data to be transmitted from the at least one SL LCH from the at least one remote WTRU that has a resource allocation mode of mode 2 that is not associated with duplicated data. The relay WTRU may transmit the triggered BSR (or SR) with the determined parameters. The resource allocation mode of a remote WTRU may be mode 1 or mode 2. The information comprising an indication of an association of SL LCHs to Uu LCHs may be an adaption layer configuration. The information received from at least one remote WTRU is a PC5-radio resource control (RRC) message. The relay WTRU may determine parameters for the triggered BSR (or SR) for the Uu LCH as the amount of data to be transmitted associated with the at least one of SL LCHs mapped to the Uu LCH with data available. The relay WTRU may cancel the BSR (or SR) for a remote WTRU data on a condition that the relay WTRU receives an indication from the remote WTRU to cancel the BSR (or SR). The relay WTRU may cancel the BSR (or SR) for a remote WTRU data on a condition that the relay WTRU receives an indication that the remote WTRU is performing mode 1 transmission. The relay WTRU may determine parameters for the triggered BSR (or SR) based on SL LCH data from remote WTRUs that have not indicated to cancel a BSR (or SR). A remote WTRU may send information to the relay WTRU: upon reconfiguration by the network, change of duplication behavior of the remote WTRU, or the remote WTRU moving into or out of coverage. A remote WTRU may determine whether to send a BSR (or SR) based on a resource allocation mode, a Uu reference signal receive power (RSRP), a Uu scheduling request (SR) configuration, a SL measurement, or a preference from the relay WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of multipath operation;

FIG. 3 is an example of a protocol view of a split bearer;

FIG. 4 is an example of packet duplication;

FIG. 5 is an example of a user plane protocol stack for L2 UE-to-Network Relay;

FIG. 6 is an example a control plane protocol stack for L2 UE-to-Network Relay;

FIG. 7 is an example of multipath operation using a same cell;

FIG. 8 is an example of multipath operation using a different cell; and

FIG. 9 is an example method of triggering a SR/BSR for a relay WTRU.

### DETAILED DESCRIPTION

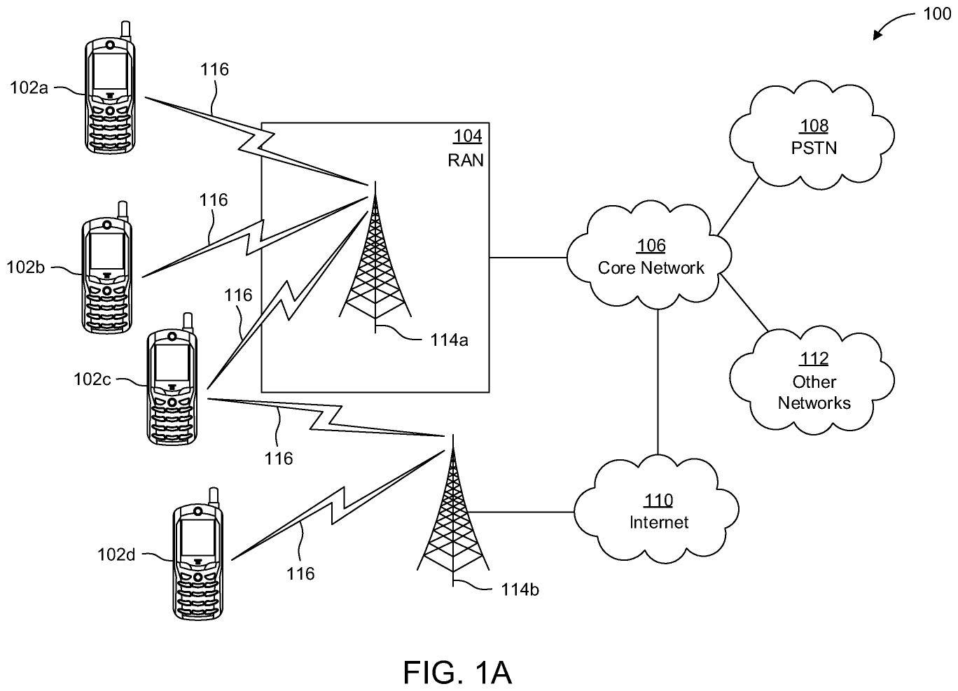

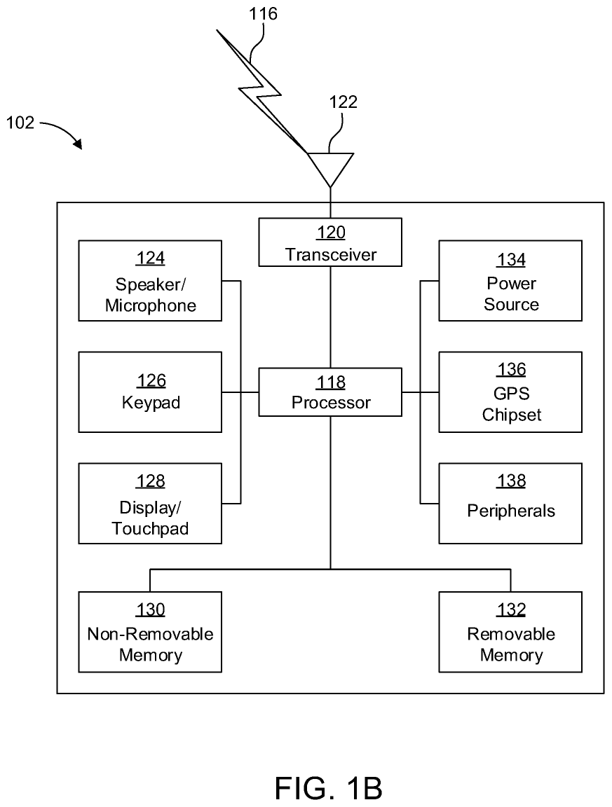

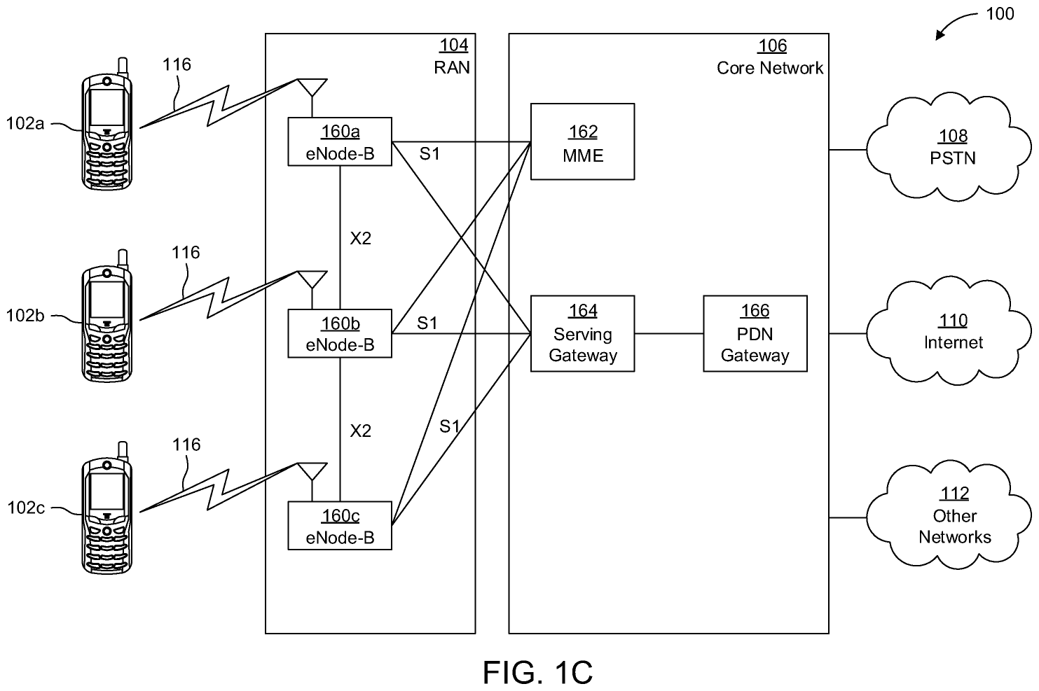

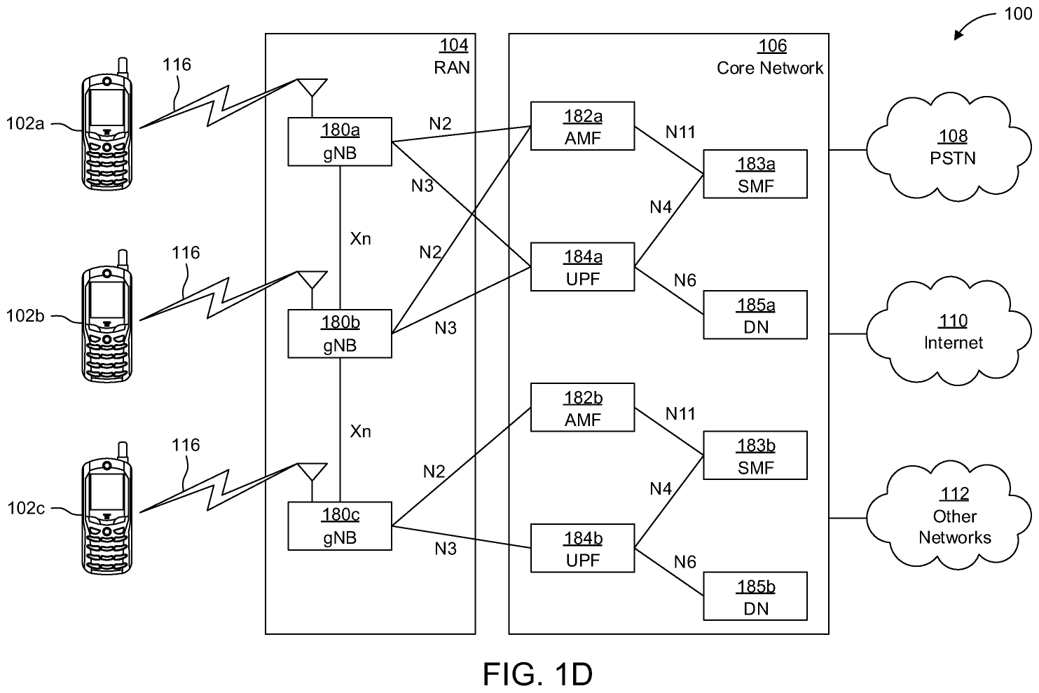

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

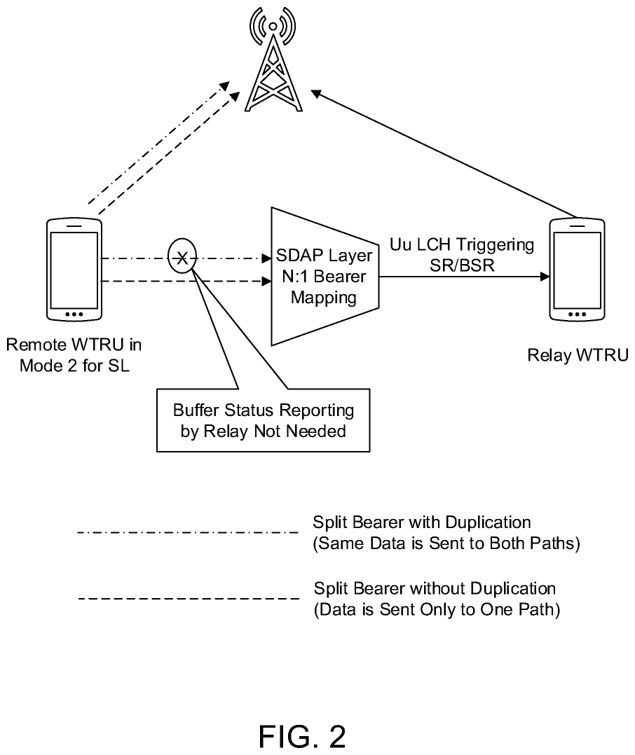

FIG. 2 shows an example of multipath operation which may comprise a remote WTRU, a relay WTRU, and a network. The remote WTRU may be in resource allocation mode 2 for sidelink (SL) transmission and may comprise a split bearer with duplication where the same data is sent to both paths (e.g. to the network and to the relay WTRU). A buffer status report (BSR) is not needed by the relay WTRU for this path from the remote WTRU to the relay WTRU for duplicated data. The remote WTRU may also comprise a split bearer without duplication where data is sent over only one path (e.g. to the network or to the relay WTRU). An SDAP layer provides a N:1 bearer mapping. The SDAP may be located in the both the remote WTRU and the relay WTRU between the PDCP layer and RLC layer. In the relay WTRU, the SDAP may be used to determine the routing between the input RLC channels and the output RLC channels. The relay WTRU receives data from the remote WTRU.

A relay WTRU may determine whether to trigger a scheduling request (SR) and/or a buffers status report (BSR) based on a scheduling or resource allocation mode indicated by a remote WTRU and a duplication status of a LCH.

The relay WTRU may receive information from the remote WTRU regarding a set of sidelink (SL) logical channels (LCHs) that are associated with duplicated data.

The relay WTRU may receive information from a network regarding a mapping, an association, or a correspondence of SL LCHs to Uu LCHs. The information may be an adaptation layer configuration.

The relay WTRU may receive an indication from the remote UE regarding a resource allocation mode (e.g. mode 1 or mode 2).

The relay WTRU may trigger a SR/BSR when data arrives at a relayed Uu LCH on condition that at least one remote WTRU is configured with mode 2 and at least one of the SL LCHs mapped to or associated with the Uu LCH with data available are not associated with duplicated data.

The relay WTRU may determine a buffer status report for the Uu LCH as an amount of data to be transmitted associated with the mapped SL LCHs that are not associated with duplicated data and associated with mode 2 transmission from the remote WTRU.

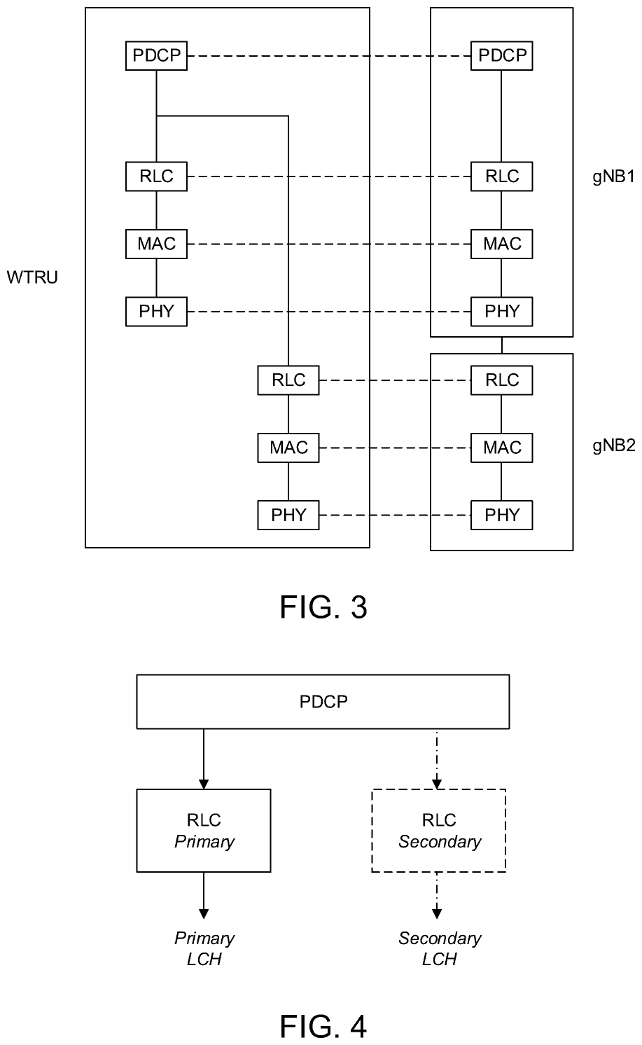

FIG. 3 shows a protocol view of a split bearer. A WTRU may have a packet data convergence protocol (PDCP) entity associated with it, and a peer PDCP entity on the network side may be terminated at one of the gNBs (i.e. either the master gNB or the secondary gNB). In the downlink, the core network (CN) may send data to a gNB where the PDCP is terminated (e.g. gNB1 in FIG. 3). The network may directly send the data to the WTRU via the link between that gNB (e.g. gNB1 in FIG. 3) and the WTRU, or may forward the PDCP PDUs to gNB2 (e.g., via a Xn interface), and gNB2 may send the data to the WTRU via the link between gNB and the WTRU.

In the uplink, a WTRU may be configured with one of the paths as a primary path and the other as a secondary path. A threshold, for example an UL split buffer threshold, may be configured. If the uplink buffer size for a bearer is less than the threshold, the PDCP may send the data only to the radio link control (RLC) associated with the primary path. If the buffer size becomes larger than the threshold, the WTRU may send the data to either path (i.e., it may be left to WTRU implementation).

FIG. 4 shows an example of packet duplication. When duplication is configured for a radio bearer by radio resource control (RRC), at least one secondary RLC entity may be added to the radio bearer to handle the duplicated PDCP PDUs, as shown in FIG. 4. The logical channel corresponding to the primary RLC entity may be referred to as the primary logical channel, and the logical channel corresponding to the secondary RLC entity or entities, may be referred to as the secondary logical channel or channels. All RLC entities involved for duplication may have the same RLC mode. Duplication at PDCP comprises submitting the same PDCP PDUs multiple times: once to each activated RLC entity for the radio bearer. With multiple independent transmission paths, packet duplication increases reliability and reduces latency and is especially beneficial for URLLC services. PDCP control PDUs may not be duplicated and may be always submitted to the primary RLC entity.

When configuring duplication for a data radio bearer (DRB), RRC may set the state of PDCP duplication (e.g. either activated or deactivated) at the time of configuration or reconfiguration. After the configuration, the PDCP duplication state may be dynamically controlled, for example by means of a MAC control element. In dual connectivity (DC), a WTRU may apply the MAC CE commands regardless of their origin (e.g. from a MCG or SCG).

When duplication is configured for a sidelink radio bearer (SRB), the state is active and may not be dynamically controlled. When configuring duplication for a DRB with more than one secondary RLC entity, RRC may set the state of each of them (i.e., either activated or deactivated). Subsequently, a MAC CE may be used to dynamically control whether each of the configured secondary RLC entities for a DRB should be activated or deactivated (i.e., which of the RLC entities should be used for duplicate transmission). A primary RLC entity may not be deactivated. When duplication is deactivated for a DRB, all secondary RLC entities associated to this DRB may be deactivated. When a secondary RLC entity is deactivated, it may not re-established, the HARQ buffers may not be flushed, and the transmitting PDCP entity may indicate to the secondary RLC entity to discard all duplicated PDCP PDUs.

When activating duplication for a DRB, the network may ensure that at least one serving cell is activated for each logical channel associated with an activated RLC entity of the DRB. When the deactivation of secondary cells (SCells) leaves no serving cells activated for a logical channel of the DRB, the network should ensure that duplication is also deactivated for the RLC entity associated with the logical channel.

When duplication is activated, the original PDCP PDU and the corresponding duplicate(s) should not be transmitted on the same carrier. The logical channels of a radio bearer configured with duplication may either belong to the same MAC entity (referred to as carrier aggregation (CA) duplication) or to different ones (referred to as dual connectivity (DC) duplication).

CA duplication may also be configured in either or both of the MAC entities together with DC duplication when duplication over more than two RLC entities is configured for the radio bearer. In CA duplication, logical channel mapping restrictions may be used in a MAC entity to ensure that the different logical channels of a radio bearer in the MAC entity are not sent on the same carrier. When CA duplication is configured for an SRB, one of the logical channels associated to the SRB may be mapped to a special cell (SpCell).

When CA duplication is deactivated for a DRB in a MAC entity (i.e., none, or only one of RLC entities of the DRB in the MAC entity remains activated), the logical channel mapping restrictions of the logical channels of the DRB may be lifted for as long as CA duplication remains deactivated for the DRB in the MAC entity.

When an RLC entity acknowledges the transmission of a PDCP PDU, the PDCP entity should indicate to the other RLC entity(ies) to discard it. In a case of CA duplication, when an RLC entity restricted to only SCell(s) reaches the maximum number of retransmissions for a PDCP PDU, the WTRU may inform the gNB but does not trigger a radio link failure (RLF).

SL-based UE to Network Relays are considered. A sidelink relay may be used to support a 5G ProSe UE-to-Network Relay (U2N Relay) function to provide connectivity to the network for U2N Remote WTRU(s). Both L2 and L3 U2N Relay architectures may be supported. The L3 U2N Relay architecture may be transparent to the serving RAN of the U2N Relay WTRU, except for controlling sidelink resources. A U2N Relay WTRU should be in a RRC_CONNECTED state to perform relaying of unicast data.

For L2 U2N Relay operation, the following RRC state combinations may be supported: (1) both a U2N Relay WTRU and a U2N Remote WTRU shall be in a RRC CONNECTED state to perform transmission/reception of relayed unicast data; and (2) the U2N Relay WTRU may be in a RRC_IDLE, RRC_INACTIVE or RRC_CONNECTED state as long as all the U2N Remote WTRU(s) that are connected to the U2N Relay WTRU are either in a RRC_INACTIVE or in RRC_IDLE state.

For L2 U2N Relay operation, the U2N Remote WTRU may only be configured to use resource allocation mode 2 for data to be relayed.

A single unicast link may be established between one L2 U2N Relay WTRU and one L2 U2N Remote WTRU. The traffic of a U2N Remote WTRU via a given U2N Relay WTRU and the traffic of the U2N Relay WTRU should be separated in different Uu RLC channels over a Uu interface.

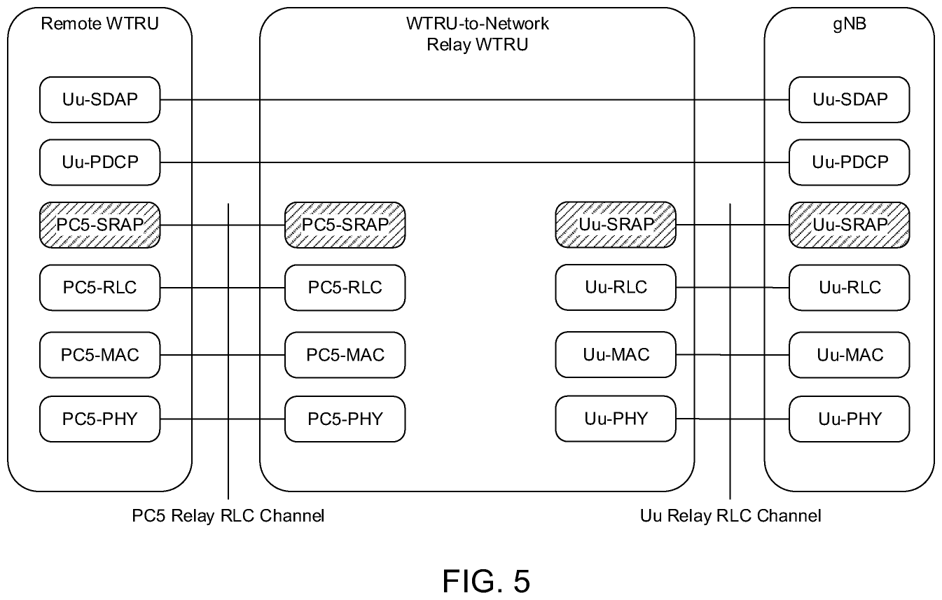

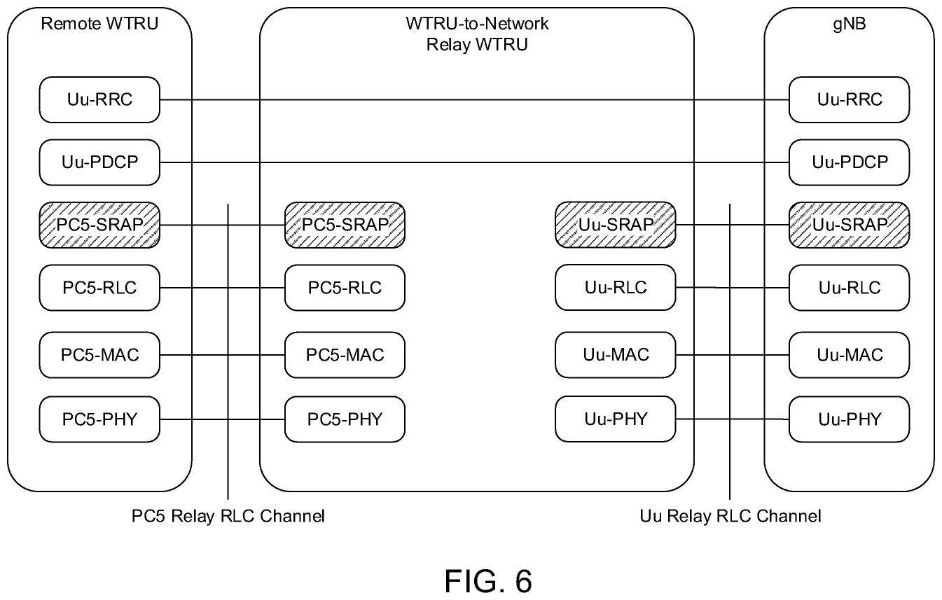

An example of a user plane (UP) protocol stack for a L2 U2N Relay is shown in FIG. 5. An example of a control plane (CP) protocol stack for a L2 U2N Relay is shown FIG. 6. A sidelink relay adaption protocol (SRAP) sublayer is placed above an RLC sublayer for both the control plane and user plane at both a PC5 interface and Uu interface. The Uu SDAP, PDCP and RRC are terminated between the L2 U2N Remote WTRU and the gNB, while the SRAP, RLC, MAC and PHY are terminated in each hop (i.e. the link between the L2 U2N Remote WTRU and L2 U2N Relay WTRU and the link between the L2 U2N Relay WTRU and the gNB).

For L2 U2N Relay operation, the SRAP sublayer over the PC5 hop may be used for the purpose of bearer mapping. The SRAP sublayer is not present over the PC5 hop for relaying the L2 U2N Remote WTRU's message on a broadcast control channel (BCCH) and a physical control channel (PCCH). For the L2 U2N Remote WTRU's message on SRB0, the SRAP sublayer is not present over the PC5 hop, but the SRAP sublayer is present over the Uu hop for both downlink and uplink.

For L2 U2N Relay operation, for uplink, the Uu SRAP sublayer supports uplink bearer mapping between ingress PC5 Relay RLC channels for relaying and egress Uu Relay RLC channels over the L2 U2N Relay WTRU Uu interface. For uplink relaying traffic, the different end-to-end RBs (e.g. SRBs or DRBs) of the same Remote WTRU and/or different Remote WTRUs may be multiplexed over the same Uu Relay RLC channel.

For L2 U2N Relay operation, for uplink, the Uu SRAP sublayer supports L2 U2N Remote WTRU identification for the UL traffic. The identity information of L2 U2N Remote WTRU Uu Radio Bearer and a local Remote WTRU ID may be included in the Uu SRAP header in the uplink so that a gNB may correlate the received packets for the specific PDCP entity associated with the correct Uu Radio Bearer of a Remote WTRU.

For L2 U2N Relay operation, for uplink, the PC5 SRAP sublayer at the L2 U2N Remote WTRU supports uplink bearer mapping between the Remote WTRU Uu Radio Bearers and egress PC5 Relay RLC channels.

For L2 U2N Relay operation, for downlink, the Uu SRAP sublayer supports downlink bearer mapping at a gNB to map end-to-end Radio Bearer (e.g. SRB, DRB) of a Remote WTRU into Uu Relay RLC channel over a Relay WTRU interface. The Uu SRAP sublayer supports downlink bearer mapping and data multiplexing between multiple end-to-end Radio Bearers (e.g. SRBs or DRBs) of a L2 U2N Remote WTRU and/or different L2 U2N Remote WTRUs and one Uu Relay RLC channel over the Relay WTRU Uu interface.

For L2 U2N Relay operation, for downlink, the Uu SRAP sublayer supports Remote WTRU identification for downlink traffic. The identity information of Remote WTRU Uu Radio Bearer and a local Remote WTRU ID may be included into the Uu SRAP header by the gNB in the downlink in order for a Relay WTRU to map the received packets from a Remote WTRU Uu Radio Bearer to its associated PC5 Relay RLC channel.

For L2 U2N Relay operation, for downlink, the PC5 SRAP sublayer at the Relay WTRU supports downlink bearer mapping between ingress Uu Relay RLC channels and egress PC5 Relay RLC channels.

For L2 U2N Relay operation, for downlink, the PC5 SRAP sublayer at the Remote WTRU may correlate the received packets for the specific PDCP entity associated with the correct Uu Radio Bearer of a Remote WTRU based on the identity information included in the Uu SRAP header.

A local Remote WTRU ID may be included in both a PC5 SRAP header and Uu SRAP header. A L2 U2N Relay WTRU may be configured by the gNB with the local Remote WTRU ID to be used in a SRAP header. The Remote WTRU may obtain the local Remote ID from the gNB via a Uu RRC message including, for example, RRCSetup, RRCReconfiguration, RRCResume and RRCReestablishment. Uu DRB(s) and Uu SRB(s) may be mapped to different PC5 Relay RLC channels and Uu Relay RLC channels in both a PC5 hop and Uu hop.

It may be the gNB responsibility to avoid a collision on the usage of a local Remote WTRU ID. The gNB may update the local Remote WTRU ID by an the updated local Remote ID via a message, for example an RRCReconfiguration message, to the Relay WTRU. The serving gNB may perform a local Remote WTRU ID update independent of the PC5 unicast link L2 ID update procedure.

Sidelink supports a scheduling or resource allocation mode 1 and mode 2. For an in-coverage WTRU, the gNB may control whether a WTRU transmits using mode 1 or mode 2.

In mode 1 scheduling, which may be used for a sidelink WTRU in a RRC_CONNECTED state, a WTRU may receive SL grants directly from the network, for example in a downlink control information (DCI). In this case, the WTRU may report a buffer status for a SL data grouped by a destination index. A destination index may correspond to a unique L2 destination ID or pair of source/destination L2 ID. The WTRU may report a SL SR if a SL grant is not available for transmission of the pending data.

In mode 2 scheduling, which may be used by a WTRU in any RRC state, or a WTRU which is out of coverage, a WTRU may be configured with a resource pool from which it may perform autonomous resource selection and scheduling. Resources may be selected by the WTRU based on information in previous sidelink control information (SCI) transmissions by other WTRU s (i.e., sensing results).

A main use case considered for layer 2 WTRU to network (NW) relays is the case of a remote WTRU out of coverage. With multipath, a remote WTRU may be assumed to be in coverage and may therefore utilize either a Uu path, SL (relayed) path, or both. Solutions for multi-path support may enhance reliability and throughput (e.g., by switching among or utilizing the multiple paths simultaneously) in the following scenarios [RAN2, RAN3]: A WTRU may be connected to the same gNB using one direct path and one indirect path via scenario (1) Layer-2 WTRU-to-Network relay, or scenario (2) via another WTRU (where the WTRU-WTRU inter-connection is assumed to be ideal). The solutions for scenario (1) may be reused for scenario (2) without precluding the possibility of excluding a part of the solutions which is unnecessary for the operation for scenario (2).

In multipath operation, the direct link between a remote WTRU and a gNB, and a backhaul link between a relay WTRU and the gNB may be served by the same gNB, or by the same cell of the same gNB. If mode 1 is used for the scheduling of the SL between the remote WTRU and the relay WTRU, the scheduling of all the links (e.g. Uu between a remote WTRU and gNB, backhaul Uu between relay WTRU and gNB, and SL between the remote and relay WTRU) may be done by the gNB. If mode2 is used and a resource pool was pre-configured by the gNB for the SL which the remote WTRU may use autonomously, the gNB may still be the one deciding the resource pool configuration, and thus have a control over the scheduling over the SL, even though it is not as real-time as in the case of mode1.

Multipath may be modelled similar to DC from a protocol architecture perspective, as different MAC entities are used for the Uu link and the SL, and the same PDCP entity is configured for a given bearer that is using the multipath (e.g., a split bearer). However, if the same gNB is serving the cells of the Uu and the SL, then one may consider this to be similar to the case of CA. However, in CA, one MAC entity is utilized, which is not the case here. To complicate things even further, the Uu and the SL may be served by the same cell of a given gNB (i.e. not even CA).

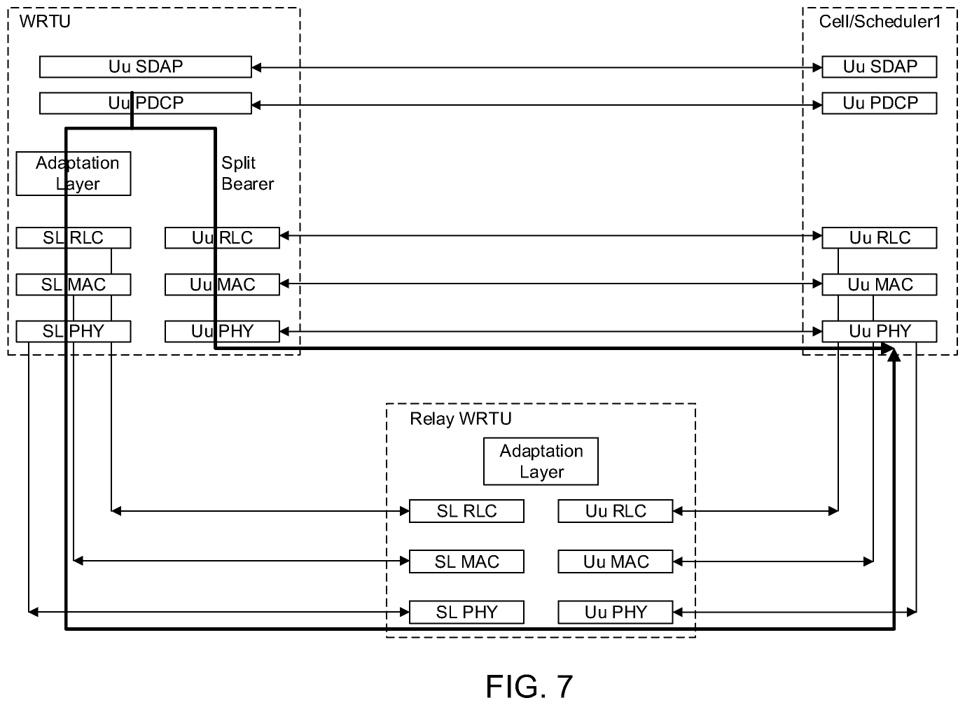

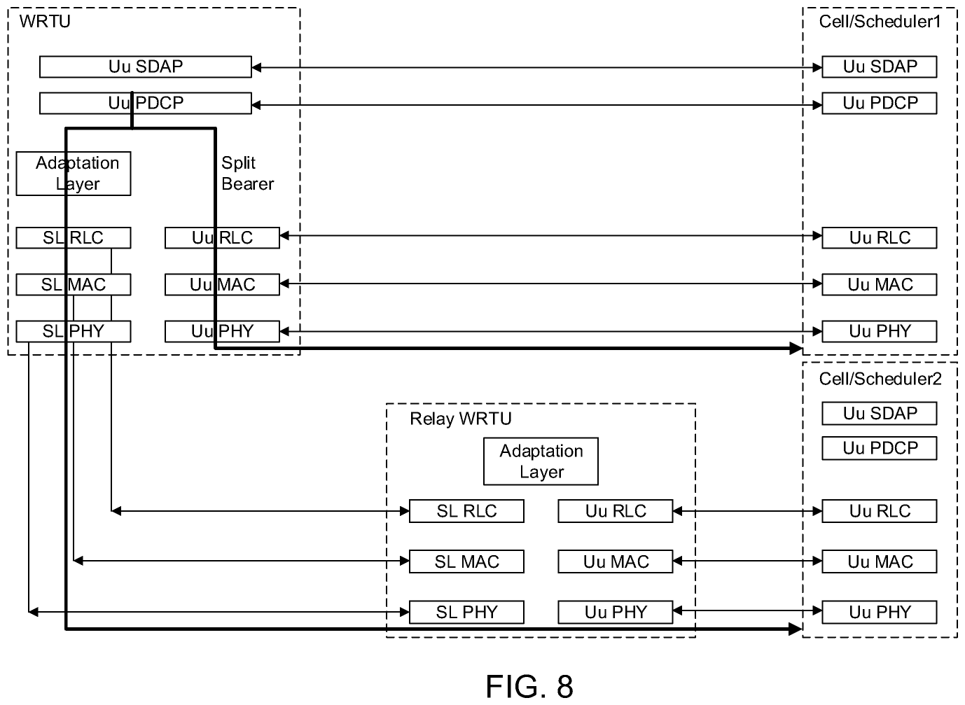

FIG. 7 and FIG. 8 shows examples on how multipath may be modelled at the protocol level.

FIG. 7 shows an example of multipath operation using a same cell. The WTRU comprises a split bearer with a Uu direct path to the cell/scheduler 1 and a SL path to the relay WTRU. The relay WTRU has a Uu path to the cell/scheduler 1.

FIG. 8 shows an example of multipath operation using a different cell. The WTRU comprises a split bearer with a Uu direct path to the cell/scheduler 1 and a SL path to the relay WTRU. The relay WTRU has a Uu path to the cell/scheduler 2.

Multipath may involve the same scheduler controlling a remote WTRU's Uu and SL paths, or even the relay WTRU's Uu path. Depending on the remote WTRU's SL scheduling mode, the relay WTRU may end up triggering redundant SR/BSR procedures. For example, if the SL scheduling mode is mode 1, the remote WTRU may send a BSR for data to be scheduled on the SL and when this data arrives at the relay WTRU, the relay WTRU may send another BSR, for getting grants over the backhaul Uu, related to the same data that the gNB has just scheduled over the SL. Also at the remote WTRU, the SL BSR and Uu BSR may be redundant for duplicated data. For example, if packet duplication is to be applied and mode 1 scheduling is used over the SL, since the MAC entities for the Uu and SL are separate, the remote WTRU may send one Uu BSR and another SL BSR to the same gNB, regarding the same data.

As a result, new SR/BSR procedures may be required in the case of multipath to avoid unnecessary Uu overhead.

Embodiments described herein may be applied when multipath behavior is configured over the same cell or over different cells of the same gNB. In some embodiments, a WTRU may only perform the behavior applicable to multipath if it is configured to do so, or if it may confirm that the two links have the same scheduler.

A remote WTRU may transmit a duplication indication to the network. The duplication indication may be sent using an RRC message. It may contain a list of the LCHs/bearers and the corresponding duplication status of that LCH/bearer. The duplication indication may be sent using a MAC CE. For example, the remote WTRU may send the duplication status (e.g. enabled/disabled) with each LCH or LCG that is reported in a BSR. In an embodiment, a WTRU may indicate to the network that duplication is enabled or disabled for one or more specific bearers. The WTRU may indicate which bearer or bearers have duplication enabled or disabled. The WTRU may send such indication upon a determination to enable or disable duplication.

A remote WTRU may be configured with a correspondence between a SL logical channel (LCH)/logical channel group (LCG) and a Uu LCH/LCG. A WTRU may receive information regarding a correspondence between a Uu LCH and a SL LCH and/or between a Uu LCG and a SL LCG. Such correspondence may indicate whether the LCHs or LCGs are being used to transmit duplicated data. Such correspondence may be used to determine whether to transmit a SL or Uu BSR for a LCH or LCG, considering a need to avoid transmitting a redundant BSR, as described herein. The WTRU may receive such correspondence information explicitly from the network (e.g., in RRC signaling). The WTRU may be preconfigured or prespecified with such correspondence information. The network may turn on or off duplication between the prespecified Uu LCHs and SL LCHs or Uu LCGs and SL LCGs.

A remote WTRU may receive signaling (e.g. MAC CE, DCI, or RRC message) from the network to turn on or off duplication between configured or prespecified SL and Uu LCHs with a correspondence. Such signaling may enable or disable duplication across all configured/prespecified LCHs, or only a subset of LCHs, which may be indicated in the signaling itself.

A remote WTRU may report one or both of a SL BSR or Uu BSR for duplication. In an embodiment, a WTRU may report a BSR for LCHs associated with duplication on a SL (relayed) path and Uu (direct) path using either a Uu BSR or a SL BSR. Herein, BSR for LCHs associated with duplication may be referred to as duplicated BSR and a duplicated LCH may refer to a LCH associated with a bearer where duplication is configured and/or activated. A WTRU may report a BSR on only one link if the buffer status includes or comprises PDUs which have been duplicated on both a Uu and SL path. If the WTRU is configured with or received information regarding a correspondence between Uu and SL LCHs, and duplication is enabled for a pair of LCHs, the WTRU may report a BSR for one of the links only for the LCHs that are configured with the correspondence.

A WTRU may determine whether to include a buffer status regarding duplicated data in a Uu BSR or SL BSR or both based on one or a combination of rules or conditions. In an embodiment, a WTRU may report a BSR via Uu or SL based on a determination of a first condition related to Uu and/or SL. If the first condition is met for reporting of BSR to both Uu and SL, then the WTRU may determine, based on a second condition, whether to report BSR via Uu or SL. For example, a WTRU may determine whether to report a BSR regarding duplicated BSR via both Uu and SL using a first condition. In case the first condition is not met and it is going to be reported using a BSR of only one of the two links, the WTRU may determine the link to use based on a second condition.

The WTRU may use any or a combination of the following rules or conditions, which may serve as either condition 1 or condition 2 in the above embodiment.

The WTRU may use a rule or condition based on a need to report a SL BSR or Uu BSR, which may be associated with non-duplicated LCHs. For example, a WTRU may report a BSR related to duplicated LCHs via the link (e.g. Uu or SL) for which the WTRU has a buffer status to report related to non-duplicated LCHs.

The WTRU may use a rule or condition based on a configuration associated to a bearer or to the WTRU itself. For example, a WTRU may be configured to report a BSR via either Uu or SL based on the configuration, which may be of the bearer being duplicated. For example, the bearer may be configured with a primary path, and the WTRU may report a BSR via the path that is configured as a primary path. For example, the WTRU may be configured as to whether to report or prioritize a report of BSR via Uu or SL.

The WTRU may use a rule or condition associated with a quality of a Uu link and/or SL link. For example, a WTRU may report duplicated BSR in a Uu reference signal receive power (RSRP) if the Uu RSRP is above a threshold. For example, a WTRU may report duplicated BSR in both a Uu BSR and SL BSR if the Uu RSRP is below a threshold.

The WTRU may use a rule or condition associated with a SR trigger. For example, if the WTRU triggers a Uu or SL SR, it may report the available data in the BSR for the same link (i.e. Uu/SL).

The WTRU may use a rule or condition associated with the need to trigger a SR and/or the availability of uplink resources to report a BSR. For example, the WTRU may report a duplicated BSR via Uu if it can include the Uu BSR using the uplink grant and/or if the Uu BSR reporting can be performed without triggering a SR.

The WTRU may use a rule or condition based on a priority of the SL and/or Uu LCHs. For example, the WTRU may report a duplicated BSR via Uu or SL depending on the SL priority and/or Uu priority. The WTRU may compare the priority with a threshold and may report a duplicated BSR via Uu or SL if it is determined that the priority is above or below the threshold.

The WTRU may use a rule or condition based on the BSR that is prioritized in the MAC layer. For example, the WTRU may report a duplicated BSR as a SL BSR if the duplicated LCHs on the SL are associated or included with the prioritized SL BSR MAC CE (i.e., they are included first in the grant). For example, if the duplicated SL LCHs are prioritized SL LCHs, the WTRU may report a duplicated BSR in a SL BSR. Otherwise, the WTRU may report the duplicated BSR in a Uu BSR.

The WTRU may use a fixed rule or condition. For example, the WTRU may report duplicated BSR in a Uu BSR. The advantage of such an approach is that it reduces the overhead of BSR reporting for the duplicated data as the L2 ID need not be reported.

The WTRU may use a rule or condition based on the availability of space based on a grant. For example, the WTRU may report a duplicated BSR in a Uu BSR if there is insufficient space to report a duplicated BSR in a SL BSR, otherwise it may report the duplicated BSR in a SL BSR. For example, the WTRU may report a duplicated BSR in both a Uu BSR and SL BSR if there is sufficient space to report the duplicated BSR in a SL BSR and Uu BSR. Otherwise, if there is insufficient space to report the duplicated BSR in both a SL BSR and Uu BSR, the WTRU may report duplicated BSR in only one of the BSR MAC CEs and may decide which one based on other rules or conditions herein.

When a WTRU decides to report a duplicated buffer status via only one link, it may drop or remove the BSR for the associated duplicated LCHs on the other link. For example, a WTRU may cancel a Uu BSR if the duplicated buffer status is reported via a SL BSR. For example, a WTRU may cancel a SL BSR if the duplicated buffer status is reported via a Uu BSR. For example, a WTRU may remove the duplicated buffer status from a Uu BSR report if the duplicated buffer status is reported via a SL BSR. For example, a WTRU may remove the duplicated buffer status from a SL BSR if the duplicated buffer status is reported via a Uu BSR. The WTRU may indicate to the network (e.g., with a flag in the BSR) that any SL or Uu BSR reported may be redundant and is reported in the BSR associated with the other link. The WTRU may indicate to the network (e.g., with a flag in the BSR or another MAC CE) that the WTRU is reporting duplicated BSR only in the BSR associated with one link (i.e. Uu BSR or SL BSR). For example, a WTRU may use a Uu/SL LCH for a bearer which may be duplicated at one time, but use the same LCH for data associated with a bearer without duplication. The WTRU, when reporting a BSR for that LCH, may indicate that duplication is associated with that LCH at the time of BSR reporting.

In an embodiment, when a BSR associated with a first link is reported, the BSR associated with the duplicated link may be down-prioritized. For example, the logical channel priority (LCP) of such down-prioritized BSR may be such that the BSR may be sent with a lower priority.

A WTRU may trigger a BSR when the duplication status of one or more LCHs changes (e.g. from duplication activated to deactivated, or vice versa).

Any combination of the above behavior for the WTRU may be performed.

A remote WTRU may trigger a Uu SR or a SL SR. A WTRU may trigger a Uu SR or a SL SR or both when data arrives for a LCH (e.g. Uu or SL) that is associated with duplication. In an embodiment, a WTRU may trigger either a Uu SR or a SL SR when data arrives for a LCH associated with duplication. A WTRU may be configured with or receive information regarding rules or conditions for which of a Uu SR or a SL SR to trigger when data arrives at a bearer configured with duplication. For example, the WTRU may trigger the SR for which the RLC entity received the data first. For example, the WTRU may trigger the SR whose SR resource (e.g. SL SR or Uu SR) occurs first in time. For example, the WTRU may trigger either a Uu SR or a SL SR depending on a configured preference from the network. For example, the WTRU may trigger the specific SR based on the presence of other (e.g. non-duplicated) data available for transmission. For example, if other data available for transmission is buffered at the WTRU on a Uu, the WTRU may trigger a Uu SR rather than a SL SR for the duplicated data. For example, the WTRU may trigger a Uu SR if the amount of Uu buffered data is larger than the amount of SL buffered data. For example, the WTRU may trigger a specific SR (e.g. Uu or SL) based on a comparison of the Uu SL LCHs associated with the duplicated bearer, which may be compared to a threshold. The WTRU may trigger a Uu SR if the Uu LCH priority is larger than a configured threshold. The WTRU may trigger a SL SR if the SL LCH priority is larger than a configured threshold. If the Uu LCH priority is above a first threshold, or the SL LCH is below a second threshold, the WTRU may trigger a Uu SR, otherwise, it may trigger a SL SR.

Once the SR (e.g. SL or Uu) is triggered, the WTRU may cancel the other SR. For example, if the WTRU triggers a SL SR, it may cancel a Uu SR. For example, if the WTRU triggers a Uu SR, it may cancel a SL SR For example, the WTRU may cancel the other SR when or if the WTRU receives a Uu grant. For example, the WTRU may cancel the other SR as long as there is no additional data to be transmitted associated with non-duplicated data on the link associated with the SR to be cancelled.

A remote WTRU may be configured with SR resources for duplicated data. In an embodiment, a remote WTRU may be configured with SR resources to be used when data arrives at a LCH associated with duplicated data. For example, if data arrives at a LCH associated with one or more LCHs for SL and Uu duplication, the WTRU may send a SR on one of the dedicated SR resources associated with duplication.

In an embodiment, a remote WTRU may use SR resources configured for LCHs associated with duplicated data for triggering a SR upon data arrival when duplication is disabled. For example, the WTRU may be configured with specific rules or conditions to allow the use of the duplication SR resource for triggering SR when duplication is disabled, such as: a priority of the data is above a threshold; a SL channel busy ratio (CBR) is above a threshold and the data arrives at a SL LCH; the load of the relay WTRU, based on for example reception of flow control messages, is above a threshold and data arrives at a SL LCH; and the time until the next non-duplicated SR configured is above a threshold.

A WTRU may signal that duplicated data is not present, despite signaling SR associated with duplicated data by, for example, sending another SR or sending a MAC CE following the transmission of the SR.

A remote WTRU may provide information related to SR/BSR coordination to a relay WTRU. A remote WTRU may send SR/BSR coordination information to a relay WTRU. For example, a remote WTRU may provide information on the SL LCHs or LCGs which represent LCHs or LCGs for which duplication is performed on a SL (relayed) path and a Uu (direct) path. Such information may be provided, for example, via PC5-RRC in the SL LCH configuration from the remote WTRU to the relay WTRU. Such information may be provided, for example, in a MAC CE (e.g., in a bitmap). Such information may be provided, for example, in a MAC header associated with the SL transmissions which correspond to duplicated LCHs.

A remote WTRU may send coordination information upon reconfiguration by the network. A remote WTRU may send coordination information upon a change of duplication behavior at the remote WTRU. For example, if the network enables duplication between SL and Uu at the remote WTRU or changes the duplication configuration, the remote WTRU may send the duplication information to the relay WTRU. If the remote WTRU enables or disables duplication for a pair of LCHs, the remote WTRU may inform the relay WTRU.

A remote WTRU may send coordination information upon moving into or out of coverage. A remote WTRU may send coordination information upon having multipath configured or de-configured.

A remote WTRU may send coordination information to the relay WTRU explicitly. For example, a remote WTRU may indicate any of or a combination of the following (e.g. in PC5-RRC): the resource allocation mode of the remote WTRU (e.g. mode 1 or mode 2 transmission) which may be associated with a specific logical channel on sidelink, if the WTRU can be configured with different resource modes for different SL LCH transmissions; the SL LCHs for which duplication is enabled/disabled or configured; whether Uu BSR and/or SL BSR was reported to the network associated with one or more LCHs, and/or the amount/percentage of BSR reported or still to be reported; and whether Uu SR and/or SL SR was triggered to the network, which may be associated with one or more LCHs.

A remote WTRU may process the coordination information and may send an indication of the SR/BSR behavior to be performed by the relay WTRU. For example, the remote WTRU may send an indication of whether Uu SR/BSR should be sent by the relay WTRU or not, which may be associated with some LCHs. For example, if the remote WTRU is configured in mode 1, the remote WTRU may indicate to the relay WTRU to not send a SR/BSR. For example, if the remote WTRU is configured in mode 2, and duplication is enabled for at least some bearers at the remote WTRU, the remote WTRU may indicate to the relay WTRU to not send a SR/BSR for the SL LCHs which are associated with the duplication. For example, if none of the conditions for the relay WTRU to abstain from sending a SR/BSR are met, the remote WTRU may send an indication to the relay WTRU indicating that the relay WTRU should send a BSR. The remote WTRU may not send an indication in this case.

Without loss of generality, the above information may also be provided by the gNB to the relay WTRU and the same embodiments may apply.

A remote WTRU may determine whether to send a SR/BSR for Uu data. In an embodiment, a remote WTRU may determine whether to send a SR/BSR itself, or whether to rely on the relay WTRU to perform a SR/BSR transmission for Uu data associated with duplication. For example, considering the relay WTRU and remote WTRU are served by the same scheduler, the relay WTRU may provide buffer status information to the network to allow the network to schedule the remote WTRU on the Uu link.

A remote WTRU may determine whether or not to send a SR/BSR for Uu data based on one or a combination of factors or conditions. The factors or conditions may be for example: a SL transmission mode, a Uu RSRP, a Uu SR configuration, SL measurements and/or SL flow control received from the relay WTRU, and a preference from the relay WTRU.

A remote WTRU may determine whether to send a SR/BSR for Uu data based on a SL transmission mode. For example, a remote WTRU may send a SR/BSR for Uu data associated with duplication only when configured with mode 2 resource allocation.

A remote WTRU may determine whether to send SR/BSR for Uu data based on a Uu RSRP. For example, a remote WTRU may send a SR/BSR when a measured Uu RSRP is above or below a threshold.

A remote WTRU may determine whether to send a SR/BSR for Uu data based on a Uu SR configuration. For example, a remote WTRU may be configured without Uu SR. Alternatively, a remote WTRU may be configured without adequate Uu SR, where adequate Uu SR may correspond to a Uu SR that is allowed to be used for the priority of the data for which the remote WTRU has to send a SR. If the remote WTRU is configured without a Uu SR, it may rely on the relay WTRU to send a SR and/or BSR. For example, the remote WTRU may subtract from any BSR reporting on Uu, the buffer status of the Uu transmissions for which BSR will be reported by the relay WTRU (e.g. BSR for duplicated Uu and SL data).

A remote WTRU may determine whether to send a SR/BSR for Uu data based on SL measurements and/or SL flow control received from the relay WTRU. For example, a remote WTRU may send a SR/BSR if the SL CBR is above or below a threshold, otherwise, it may rely on the relay WTRU to send a SR/BSR.

A remote WTRU may determine whether to send a SR/BSR for Uu data based on a preference or indication from the relay WTRU. For example, the relay WTRU may indicate that it prefers or does not prefer to send a SR/BSR or not, and the remote WTRU may determine whether to send a SR/BSR based on the relay WTRU's preference. For example, if the relay WTRU prefers to send a SR/BSR, the remote WTRU may not send a SR/BSR.

A relay WTRU may determine whether to trigger a SR/BSR based on information from a remote WTRU.

A relay WTRU may cancel a SR/BSR following reception of an indication from the remote WTRU indicating such or providing SR/BSR coordination information. For example, a relay WTRU may receive an indication that a Uu SR/BSR should not be triggered. Following reception of such indication, a relay WTRU may cancel a Uu SR/BSR triggered whenever uplink data arrives at the relay WTRU for any LCH associated with relaying from that remote WTRU.

For example, a relay WTRU may receive an indication that a remote WTRU is in mode 1 transmission. Following reception of such indication, the relay WTRU may not trigger SR/BSR following reception of any data from that remote WTRU that would normally trigger SR/BSR, but may trigger SR/BSR for other remote WTRUs and/or for the relay WTRU's own data.

For example, a relay WTRU may receive an indication that a remote WTRU is in mode 2, and that a set of SL LCHs for that remote WTRU are being duplicated on Uu. When a relay WTRU receives data from the remote WTRU on the indicated SL LCHs, the relay WTRU may not transmit a SR/BSR, but if the relay WTRU receives data from another LCH from the remote WTRU or from another remote WTRU, the relay WTRU may trigger SR or send a BSR.

A relay WTRU may determine whether to cancel or send an SR, and/or whether to send a BSR (and the amount of BSR data to send) based on mapping or association. The mapping or associate may be an adaption layer mapping or association. For example, for a given Uu LCH which may or may not trigger a SR/BSR, the relay WTRU may determine whether to trigger a SR/BSR based on an indication or information received from all WTRUs and LCHs multiplexed onto the same Uu LCH. For example, if at least one remote WTRU connected to the relay WTRU, for which a SL LCH is mapped to the Uu LCH in question, does not indicate to cancel a SR (or at least one remote WTRU indicates to not cancel a SR) associated with a SL LCH mapped to that Uu LCH, the relay WTRU may trigger a SR/BSR. The relay WTRU may compute or determine a BSR to be reported for a Uu LCH by computing or determining only the portions of the data received from the WTRUs that have not indicated to cancel a SR/BSR.

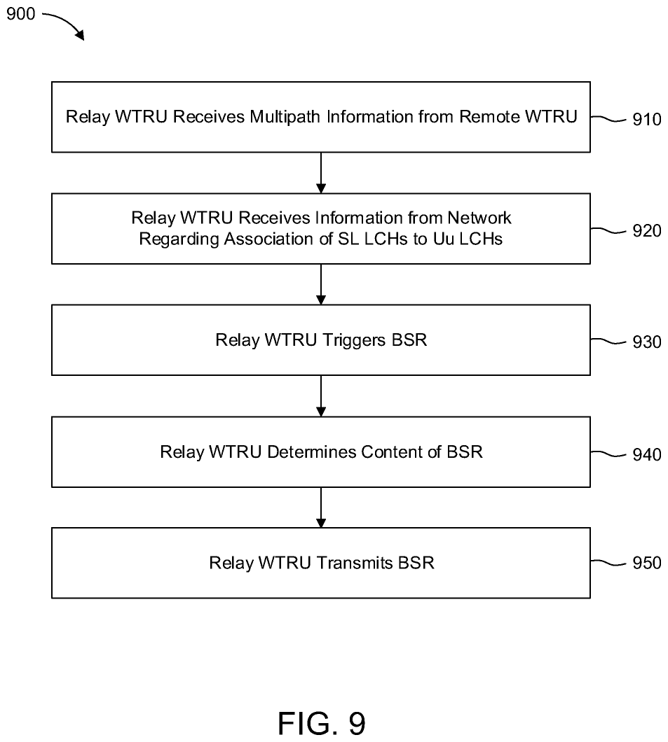

In an embodiment, a relay WTRU may determine to trigger a SR/BSR based on information from a remote WTRU and/or a network. FIG. 9 shows a method 900 for triggering and sending a SR/BSR for a relay WTRU. A relay WTRU may receive multipath information from a remote WTRU 910. The information may be a PC5-RRC message. The information from the remote WTRU may indicate a set of SL LCHs that are associated with duplicated data. The information from the remote WTRU may indicate a resource allocation mode of the remote WTRU (e.g. mode 1 or mode 2). The indication of a set of SL LCHs that are associated with duplicated data and the indication of a resource allocation mode may be in a same message or separate messages. The relay WTRU may receive multipath information from a plurality of remote WTRUs.

The relay WTRU may receive information from a network regarding an association or mapping of SL LCHs (or LCGs) to Uu LCHs (or LCGs) 920. The information from the network may be an adaption layer configuration information. The information may be received, for example, in an RRC message.

The relay WTRU may determine whether to trigger a SR/BSR 930. For example, the relay WTRU may trigger a SR/BSR when data arrives at the relayed Uu LCH and on a condition that at least one remote WTRU (with a SL LCG mapped to or associated with that relayed Uu LCH) is configured with mode 2 and at least one of the SL LCHs mapped to the Uu LCH with data available is not associated with duplicated data.

The relay WTRU may compute or determine the content or parameters of the SR/BSR 940. The relay WTRU may compute or determine the content of the BSR based on the multipath information from the remote WTRU (or remote WTRUS) and the information from the network. The relay WTRU may compute or determine the content of the BSR for the relayed Uu LCH as an amount of data to be transmitted which is mapped to or associated with the SL LCHs that are not associated with duplicated data and associated with mode 2 transmission. The BSR may inform the network regarding uplink data volume in the WTRU. For example, the content or parameters of the BSR may include, but are not limited to: amount of uplink data for a logical channel, identification of a logical channel and/or logical channel group, a buffer size field, a total amount of uplink data available, a total amount of uplink data available across logical channels of a logical channel group, and/or an index that indicates a buffer size value. The SR is used by the WTRU for requesting uplink shared resources for a new transmission.

The relay WTRU may transmit the SR/BSR 950. The SR/BSR may be transmitted to the network, which may be a gNB. The SR may be sent, for example, over a PUCCH. The BSR may be sent, for example in a MAC CE over a PUSCH.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use by a relay wireless transmit/receive unit (WTRU), the method comprising:
receiving information from at least one remote WTRU, wherein the information from the at least one remote WTRU comprises an indication of a set of sidelink (SL) logical channels (LCHs) that are associated with duplicated data and an indication of a resource allocation mode of the at least one remote WTRU;
receiving information from a network, wherein the information from the network comprises an indication of an association of SL LCHs to Uu LCHs;
triggering a buffer status report (BSR) based on SL LCH data associated with a Uu LCH of the relay WTRU arriving from at least one remote WTRU that has a resource allocation mode of mode 2 and based on at least one SL LCH from the at least one remote WTRU that has a resource allocation mode of mode 2 not being associated with duplicated data;
determining parameters for the triggered BSR for the Uu LCH of the relay WTRU based on an amount of data to be transmitted from the at least one SL LCH from the at least one remote WTRU that has a resource allocation mode of mode 2 that is not associated with duplicated data; and
transmitting the triggered BSR with the determined parameters.

2. The method of claim 1, wherein the resource allocation mode of a remote WTRU is mode 1 or mode 2.

3. The method of claim 1, wherein the information comprising an indication of an association of SL LCHs to Uu LCHs is an adaption layer configuration.

4. The method of claim 1, wherein the information received from at least one remote WTRU is a PC5 radio resource control (RRC) message.

5. The method of claim 1, further comprising:
determining parameters for the triggered BSR for the Uu LCH as the amount of data to be transmitted associated with the at least one of the SL LCHs mapped to the Uu LCH with data available.

6. The method of claim 1, further comprising:
cancelling the BSR for a remote WTRU data based on the relay WTRU receiving an indication from the remote WTRU to cancel the BSR.

7. The method of claim 1, further comprising:
cancelling the BSR for a remote WTRU data based on the relay WTRU receiving an indication that the remote WTRU is performing resource allocation mode 1 transmission.

8. The method of claim 1, further comprising:
determining parameters for the triggered BSR based on SL LCH data from remote WTRUs that have not indicated to cancel a BSR.

9. The method of claim 1, further comprising receiving information from the at least one remote WTRU: upon reconfiguration by the network, change of duplication behavior of the remote WTRU, or the remote WTRU moving into or out of coverage.

10. (canceled)

11. A relay wireless transmit/receive unit (WTRU) comprising:
a receiver;
a transmitter; and
a processor, wherein:
the receiver is configured to receive information from at least one remote WTRU, wherein the information from the at least one remote WTRU comprises an indication of a set of sidelink (SL) logical channels (LCHs) that are associated with duplicated data and an indication of a resource allocation mode of the at least one remote WTRU;
the receiver is further configured to receive information from a network, wherein the information from the network comprises an indication of an association of SL LCHs to Uu LCHs;
the processor is configured to trigger a buffer status report (BSR) when SL LCH data associated with a Uu LCH of the relay WTRU arrives from at least one remote WTRU that has a resource allocation mode of mode 2 and on a condition that at least one SL LCH from the at least one remote WTRU that has a resource allocation mode of mode 2 is not associated with duplicated data;
the processor is further configured to determine parameters for the triggered BSR for the Uu LCH of the relay WTRU based on an amount of data to be transmitted from the at least one SL LCH from the at least one remote WTRU that has a resource allocation mode of mode 2 that is not associated with duplicated data; and
the transmitter is configured to transmit the triggered BSR with the determined parameters.

12. The WTRU of claim 11, wherein the resource allocation mode of a remote WTRU is mode 1 or mode 2.

13. The WTRU of claim 11, wherein the information comprising an indication of an association of SL LCHs to Uu LCHs is an adaption layer configuration.

14. The WTRU of claim 11, wherein the information received from at least one remote WTRU is a PC5-radio resource control (RRC) message.

15. The WTRU of claim 11, wherein the processor is further configured to determine parameters for the triggered BSR for the Uu LCH as the amount of data to be transmitted associated with the at least one of the SL LCHs mapped to the Uu LCH with data available.

16. The WTRU of claim 11, wherein the processor is further configured to cancel the BSR for a remote WTRU data on a condition that the relay WTRU receives an indication from the remote WTRU to cancel the BSR.

17. The WTRU of claim 11, wherein the processor is further configured to cancel the BSR for a remote WTRU data on a condition that the relay WTRU receives an indication that the remote WTRU is performing resource allocation mode 1 transmission.

18. The WTRU of claim 11, wherein the processor is further configured to determine parameters for the triggered BSR based on SL LCH data from remote WTRUs that have not indicated to cancel a BSR.

19. The WTRU of claim 11, wherein the receiver is further configured to receive information from the at least one remote WTRU: upon reconfiguration by the network, change of duplication behavior of the remote WTRU, or the remote WTRU moves into or out of coverage.

20. (canceled)
